(19) United States
(12) Patent Application Publication
(10) Pub. No.: US 2002/0120581 A1
(43) Pub. Date: Aug. 29, 2002

(54) Reply based electronic mail transactions

(76) Inventors: Vincent J. Schiavone, Berwyn, PA (US); James H. Koenig, Philadelphia, PA (US)

Correspondence Address: Gregory S. Bernabeo, Esquire, Synnestvedt & Lechner LLP, 2600 Aramark Tower, 1101 Market Street, Philadelphia, PA, 19107-2950, US

(21) Appl. No.: 09/792,912

(22) Filed: Feb. 26, 2001

(51) Int. Cl. G06F 17/60

(52) U.S. Cl. 705/64

(57) ABSTRACT

A rule-based electronic mail transaction system and method for conducting predefined transactions via electronic mail messaging. An electronic mail message prescribes a reply action for confirming agreement to conduct the transaction. If the recipient performs the action, a rule for conducting the transaction is identified. The rule defines data required for the transaction. Required data is gathered from a recipient data store responsive to a confirming action on the part of the recipient. The required data is used to complete the transaction. Optionally, information may be retrieved from the sender's side to complete the transaction. Diverse transactions may be conducted in this manner, including sale and non-sale transactions, such as promotional and viral marketing, charitable donations, online bill payment, electoral voting, customer service communications, customer relationship management communications, product returns, and membership and enrollment transactions.

### FIELD OF THE INVENTION

This invention relates generally to the field of electronic mail and particularly to a system and method for conducting transactions via a electronic mail infrastructure.

### BACKGROUND OF THE INVENTION

Communications networks, such as the Internet, are now being widely used internationally for sending and receiving predominantly textual electronic mail (“e-mail”) messages. While e-mail has long been used for personal matters, it is now being heavily used for marketing, customer relationship management (“CRM”) and/or other commercial (collectively, “commercial”) purposes.

A simplified explanation of electronic mailboxes, electronic mail addresses, and the operation of a typical e-mail system is provided in U.S. Application No. ______ (Attorney Docket No. P24618 USA), filed , now U.S. Pat. No. ______, issued ______, the disclosure of which is incorporated herein by reference.

Presently, e-mail is a free-form communications tool typically used for correspondence. Few standards, conventions, protocols, or laws (collectively, “standards”) apply to govern how the e-mail communications medium is used and, to the extent such standards exist, there are no common e-mail formats, elements, structures, layouts or conventions that can be used to systematically conduct, process or filter common transactions, communications or actions. The lack of standards reduces the efficiency of email as a communications tool as well as for transactional purposes, i.e., for commercial transactions and/or for any predetermined structured purpose. For example, it is possible for a buyer to communicate with a seller via free-form e-mail messages to complete a sales transaction. However, there are no standards that govern use of e-mail to facilitate a sales or other electronic commerce (“e-commerce”) transactions via e-mail in a standardized manner. Accordingly, lengthy free-form textual discussions via e-mail must take place to complete a transaction, possibly resulting in missing elements of required information, typographical errors, and inefficient use of time.

A substantial amount of e-commerce is now conducted via a World Wide Web-based interface. For example, a buyer may purchase a book from a vendors website by selecting appropriate hyperlinks while connected to the Internet and/or typing appropriate information into electronic forms displayed via the website on a video monitor of a buyer's computer. Typically, the appropriate information requires sensitive information, such as a credit card number. Sending such information can pose a security risk, which is heightened as the user spends more time on a persistent Internet connection. Many Web pages containing such forms are configured with security measures to encrypt transmitted data or otherwise reduce the security risk.

U.S. Pat. No. 5,960,411 to Hartman et al. discloses a system and method for placing an order via a communications network that reduces security risks associated with transmission of sensitive information via a public communications network, such as the Internet or World Wide Web. This patent is assigned to Amazon.com, Inc. of Seattle, Washington, U.S.A. Amazon.com, Inc. appears to implement this technology as part of its “1-click” ordering system accessible via its website at URL http://www.amazon.com. This technology involves use of a client system for displaying information identifying a sale item and, in response to only a single action being performed (e.g. one click of a mouse), sending a request to order the item along with an identifier of a purchaser of the item to a server system. This is implemented through the use of “cookies” as is well known in Web-based communications networks. A single-action ordering component of the server system then receives the request, retrieves additional information previously stored for the purchaser identified by the identifier in the received request; generates an order to purchase the requested item for the purchaser identified by the identifier in the received request using the retrieved additional information; and fulfills the generated order to complete purchase of the item. In this manner, the buyer's sensitive information, such as credit card information, need not be repeatedly transmitted via the communications network. Rather, it is stored by the vendor, along with other identifying information, such as a shipping address, etc. Only the identifier need be stored at the client and transmitted to the sender. See, e.g., Hartman, col. 2, lines 50-62; col. 4, lines 54-58. This helps resolve security issues.

Web-based purchase transactions require a continuous Web-protocol connection to a communications network. Such an arrangement may be disadvantageous because of the cost, lack of spontaneity or inconvenience to the buyer, e.g. where such a transaction requires additional increments of network connection time. This is particularly true of handheld personal digital assistants, such as a Palm VII® device. Additionally, many prospective buyers may have an electronic-mail based network connection, e.g., an Internet connection, and yet not have the capability, or have a limited ability, to use a Web-based interface. This limitation is typical of Web-enabled wireless telephones, personal digital assistants, pagers, instant messaging-enabled devices, and other asynchronous communications devices.

Accordingly, it would be desirable to have an electronic mail transaction system for conducting transactions via an electronic mail infrastructure in a systematic, simplified manner.

### SUMMARY OF THE INVENTION

The present invention provides a system and method for conducting transactions via an electronic mail infrastructure in a systematic manner that simplifies interaction for senders and recipients of electronic mail messages. Generally, the system provides for conducting of predefined transactions via electronic mail messaging, which permits users to conduct transactions without a continuous network connection, i.e., in “burst” mode or asynchronously. This conserves network resources, reduces costs to users, and reduces security risks associated with persistent network connections. Additionally, the system permits transactions to be conducted exclusively via the electronic mail medium, rather than via a Web-based protocol, enabling participation of a broader base of users. Violators of the system guidelines can be barred from using the system, which protects users of the system.

The user authorizes completion of the transaction in a simplified way, which need not include manually providing, e.g. typing, data required to complete the transactions. Data may be assembled exclusively from a recipient's private profile information stored on a recipient's communications device, which protects the privacy of users of the system and gives the recipient control over how and when his data is distributed. The data can be assembled responsive to a simple action on the part of the recipient (such as typing a word, or letter, or selecting a link or other “button” by clicking a mouse), which makes the transaction simple to complete.

An action to be taken by the user to authorize completion of the transaction may be prescribed in the e-mail message or established by convention, e.g., when dealing with a certain party or group of parties. In accordance with the present invention, senders and receivers can communicate via electronic mail in accordance with a specified rule from among a common set of rules. The rule defines the data elements required for completion of the transaction. In one embodiment, establishment and/or approval of rules by a trusted third party intermediary protects and engenders trust in users of the system. The rule ensures that all necessary information is included in the message. Optionally, information may be retrieved from the sender's side to complete the transaction.

The method generally involves receiving an electronic mail message indicating a party's desire to conduct a transaction, identifying a rule applicable to the electronic mail message, retrieving from a first data store data required by the rule, and processing the data to conduct the transaction.

Devices for carrying out the inventive method and a system including such devices are also provided.

### DESCRIPTION OF THE DRAWINGS

FIG. 1 is a flow diagram of an exemplary rule-based electronic mail transaction in accordance with the present invention, shown from a sender's perspective;

FIG. 2 is a flow diagram of the transaction of FIG. 1, shown from a recipient's perspective;

FIG. 3 is a block diagram of an electronic mail transaction system in accordance with the present invention.

### DETAILED DESCRIPTION

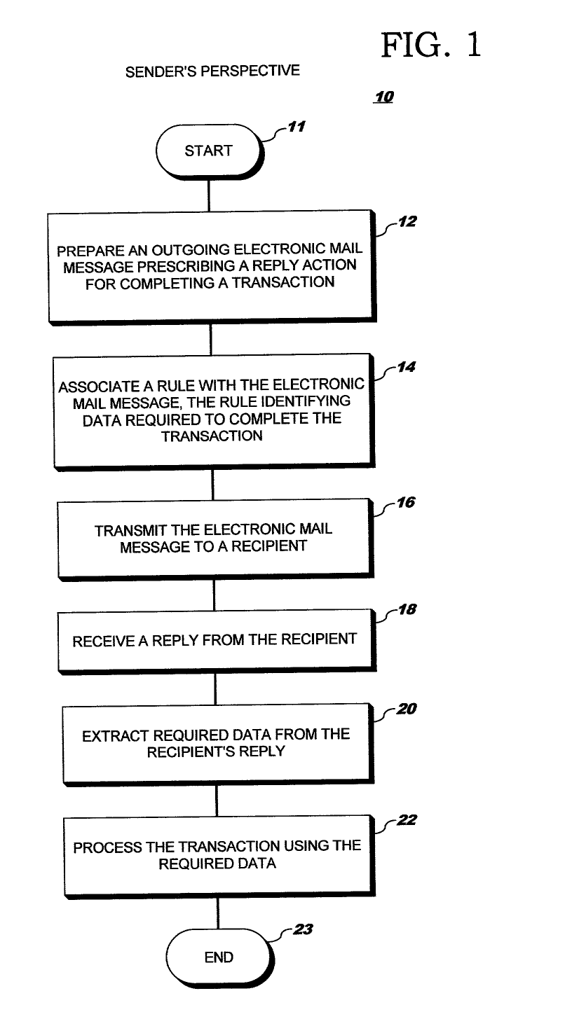

FIG. 1 is a flow diagram 10 of an exemplary rule-based electronic mail transaction in accordance with the present invention. FIG. 1 is shown from a sender's perspective. As shown in FIG. 1, the transaction begins with preparation of an outgoing electronic mail message, as shown at steps 11 and 12. This can be performed with an appropriate communications device storing and running appropriate mail composing or instant messaging software, as is well known in the art. Examples of such devices include a general purpose personal computer, a Web-enabled wireless telephone, a personal digital assistant such as a Palm VII® device, a pager, etc.

Preferably, the electronic mail message provides information about the proposed transaction in the body, header information, or in a new field reserved specifically for this purpose. Many different kinds of transactions can be conducted in this manner. As used herein, a transaction includes any solicitation for an agreement for a recipient to do something that requires authorization by the recipient. Examples include sales or other commercial transactions (e.g., “Do you want to buy a . . . ”). Examples of non-sale transactions include promotional marketing (e.g., “Would you like to receive a six month trial subscription to . . . ”), charitable donations (e.g., “Would you like to make a donation to . . . ”), bill payment (e.g., “Would you like to pay the attached billing statement from . . . ”), electoral voting, customer service communications, customer relationship management communications, product returns, membership and enrollment transactions, etc.

Preferably, the electronic mail message expressly prescribes a certain reply action for completing a transaction. For example, the message could include the statement “Click the YES button below to authorize the transaction.” or “Select the REPLY button to complete the transaction.” A button, or any image, text or other link acting as a “button” can be included in an electronic mail message using HTML and/or other techniques known in the art. Alternatively, for example, the mail message may require the recipient to transmit a reply message indicating authorization to complete the transaction. For example, as an identity verification or anti-fraud measure, the recipient may be required to use a reply function of the recipient's mail client software to send a reply message to the sender and/or other specified party. The electronic mail message typically includes one or more electronic mail addresses for this purpose. The reply functionality is well known in the art of electronic mail messaging. Such a reply may include the original text of the message. Alternatively, the recipient may be required to simply send an electronic mail message to the sender and/or other specified party. The sending of the reply may be sufficient. Alternatively, the recipient may be required to type a keyword such as YES, a code, the recipient's name, attach a digital signature, etc. For some transactions, the recipient may be required to specify keywords such as a color, style, size, quantity or other code or specifier to provide sufficient information to complete the transaction.

For illustrative purposes, consider a rule for conducting a sale of a certain beauty product for $19.95. When the sender of an electronic mail message wishes to send a money order to a recipient via electronic mail, the sender composes an electronic mail message addressed to the recipient, for example, an electronic mail message reading “Do you want to buy this cosmetics kit for $19.95? If so, click REPLY to buy.”

A rule is then associated with the electronic mail message, as shown at step 14. The rule requires certain data for completing the transaction. For example, for a sales transaction, a digital signature verifying the identity of the recipient, the recipient's name, shipping address and credit card number may be required by the rule. In the example of FIG. 1, the rule will be used by the recipient's communications device to identify data required by the rule at the recipient's communications device. Alternatively, the rule may be used by an intermediary's or the sender's communications device to identify at least some of the required data, in embodiments in which such parties store such data. The recipient need not type or otherwise manually provide such information, which makes the transaction easy to conduct from the recipient's perspective.

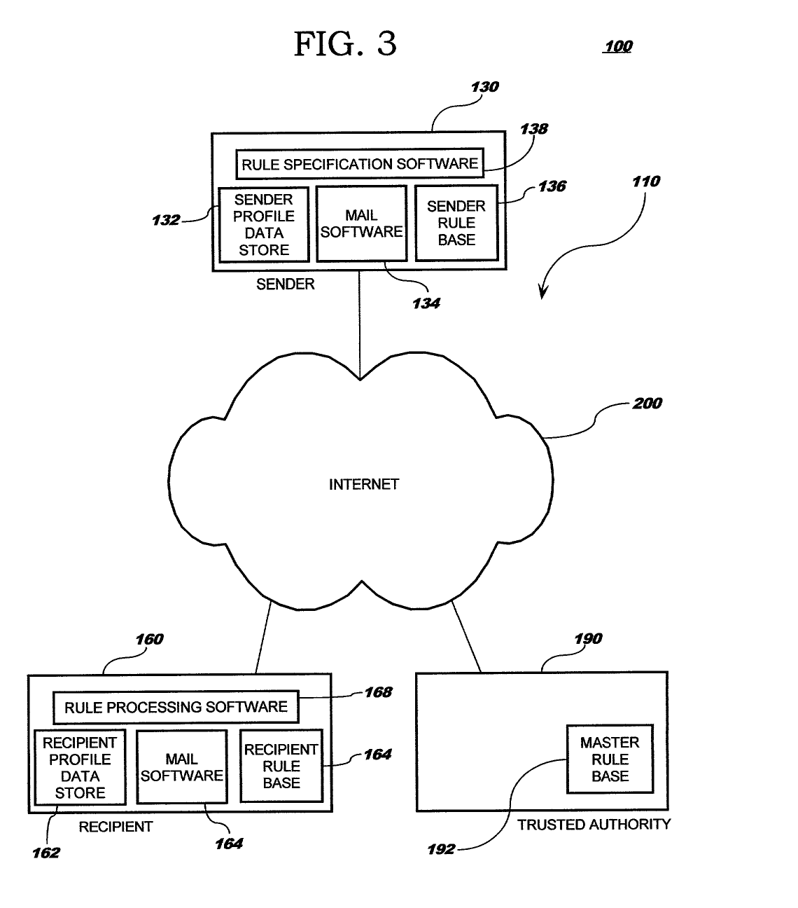

The rule is selected from a set of standardized rules or customized/modified rules shared by one or more subscribers, i.e. participants in the system such as a sender or a receiver, to the electronic mail transaction system. The rule may be specified automatically by the sender's communications device using rule specification software, as shown at 138 in FIG. 3. Methods and techniques for implementing rule specification and referencing software for carrying out the steps of the inventive method are well known in the art. For example the rule itself may be included in the electronic mail message. Alternatively, the sender may simply specify an associated rule and the rule itself may be stored on the recipient's client device, the recipient's network, at a trusted authority's server, at a third party, or otherwise on a distributed, network-accessible basis. For example, the sender may type a rule specifier or keyword into a body portion of the message. In another embodiment, a graphic seal (e.g., a trade organization or a trusted authority may specify common rule sets and associated seals indicating compliance with said rules) included as an object in the message may signify application of a corresponding rule. In yet another embodiment, the sender may select a rule from a menu of rules displayed on the sender's communications device. Mail composition software must be modified using known techniques to provide for presentation of such a menu and/or automatic designation of a rule.

In the example of FIG. 1, a “SALE” rule specifier is embedded in the message in step 14. For example, the specifier may be inserted into a viewable content portion of the message or embedded in hidden header information of the message. For illustrative purposes, consider that a rule specifier is embedded in a header information portion of the message by rule specification software. The rule specifier may be used to reference a data store of rules to identify a corresponding rule, e.g. by a recipient or sender of the message.

The electronic mail message is then transmitted to an intended recipient via a communications network using an electronic mail infrastructure, as shown at step 16. This may be accomplished using known electronic mail transmission hardware and software, as is well known in the art.

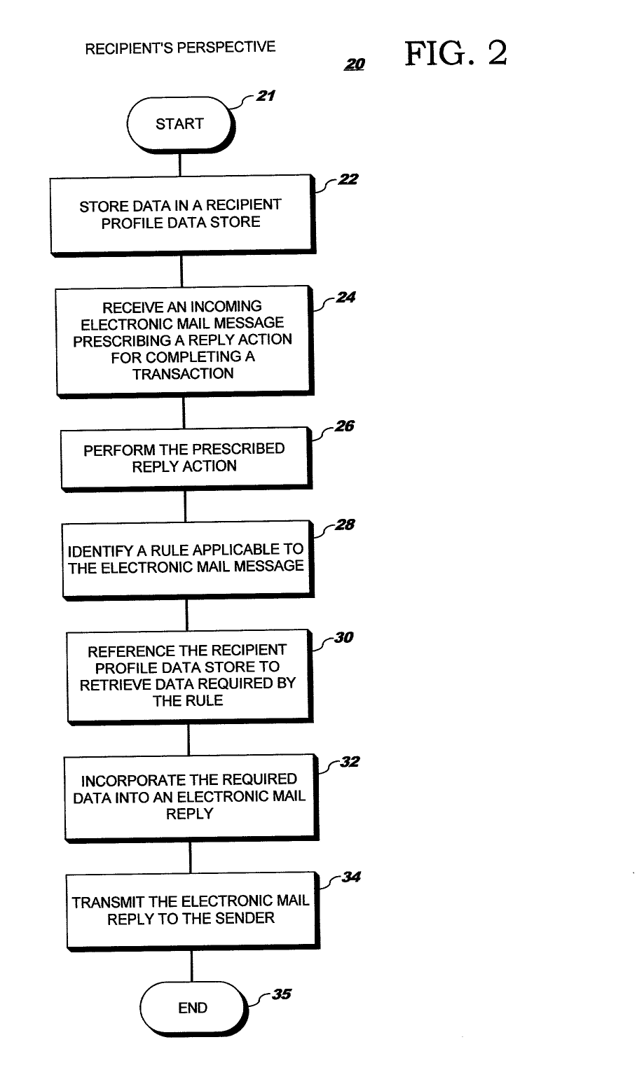

FIG. 2 is a flow diagram 20 of the transaction of FIG. 1, shown from a recipient's perspective. As shown in FIG. 2, the transaction starts with the recipient's storage of data in a recipient profile data store, as shown at steps 21 and 22. The recipient profile data store stores data specific to the recipient. Although the information may be a common or short-hand recipient identification code, this information is typically generic, rather than application specific. Accordingly, such information differs from an application-specific “cookie” of the type generally known in communications networks. For example, the recipient profile data store may store the recipient's name, address, telephone number, age, sex, favorite color, marital status, social security number, birth date, primary bank account number, the primary bank's ABA routing number for electronic funds transfers, credit card number, etc. It should be appreciated that such information could be used for a wide variety of transactions with a diverse parties—vendors, service providers, direct marketers, etc. and that not all such information is likely to be required by any one party for any one transactions. Which of these data elements is required for a given transaction is determined by an appropriate rule, rather than by the recipient, which makes the transaction simple to complete from the recipient's perspective. The recipient profile data store is preferably stored locally, i.e., in the memory of the recipient's communications device to ensure that confidentiality of the data is preserved. However, the recipient profile data may be stored remotely, e.g., in a memory of the sender's communications device, at a trusted authority, a third party, or otherwise on a distributed basis accessible via a communications network.

As shown in FIG. 2, the recipient next receives the electronic mail message, as shown at step 24. The electronic mail message may be received via a communications device and/or software that is well known in the art.

If the recipient wishes to conduct the transaction described in the electronic mail message, e.g., buy the beauty product, the recipient performs the prescribed transaction, as shown in step 26. For example, the recipient uses an input device of his communications device to select a REPLY command of a standard mail software program.

In the example of FIGS. 1-2, the recipient's communications device next identifies a rule applicable to the electronic mail message, as shown at step 28. Methods and techniques for implementing rule processing software for carrying out this step are well known in the art. For example, this may involve scanning the message for a rule or a rule specifier, such as a keyword, image, etc. In the example of FIG. 2, the message includes a rule specifier. For example, the rule specifier may be contained in a body portion, header portion or a new purposes-specific field of the electronic mail message included in accordance with the present invention. Step 28 includes referencing a data store of rules to identify a corresponding respective rule. The data store of rules may be stored locally, e.g., in a memory of the recipient's communications device, or remotely, e.g. on the recipient's network, at a trusted authority, at a third party, or otherwise on a distributed basis accessible via a communications network. Preferably the data store of rule is stored locally so that the rule can be processed, and the data required by the rule retrieved, while the recipient's communications device is disconnected from any communications network so that a message can be received via electronic mail while a connection is maintained, the connection terminated and the rules processed offline, and then the required data transmitted during a short “burst” connection to the communications network. In an alternate embodiment, in which the rules and/or the data is stored at an intermediary such as a trusted authority, the referencing of the rule and gathering of the data required by the rule may be performed after transmission by the original recipient and before receipt by the original sender.

Implicitly, step 28 involves identifying data elements required by the rule applicable to the electronic mail message. For illustrative purposes, consider that the beauty product sale rule associated with the SALE rule specifier includes information about the identity of the beauty product and requires the following data elements: the RECIPIENT FULL NAME, the RECIPIENT'S SHIPPING ADDRESS, and the RECIPIENT'S CREDIT CARD NUMBER to complete the beauty product sale transaction. Each of these data elements are specific to the beauty product sale transaction (and rule) and generic as to the recipient. None of these data elements need to be supplied by or known to the sender (although the sender would need an electronic mail address for the recipient). The rule ensures that all this information will be compiled so that the beauty product sale transaction can be completed. Rules may be established by individual senders and receivers but are advantageously established by a trusted authority.

The recipient profile data store is then referenced to identify and retrieve recipient-specific data for each required data element, as shown in step 30. For illustrative purposes, consider that the recipient's full name is John F. Doe, his shipping address is 123 Main Street, Springfield, Mass. 99999, and his credit card number is 1234567890.

The data associated with the data required by the rule is then associated with the electronic mail message, as shown at step 32. For example, this may involve displaying the data in association with the electronic mail message, e.g. via the recipient's communications device. For example, this may be achieved by creating a new mail message to the sender or to a specified electronic mail address, or by using known reply functionality of a mail software program, e.g., to reply to an electronic mail address specified in the electronic mail message. The reply may optionally contain the content of the original electronic mail message. Steps 30 and 32 require software in accordance with the present invention for retrieving the data and incorporating the data into a message.

In the example of FIGS. 1-2, the electronic mail message is modified to include the data associated with the data elements required by the rule, e.g., by appending, embedding, or otherwise incorporating the data into the message to form a reply message. For example, such data may not be readily viewable but rather hidden in a header information portion of the reply message and/or encrypted generally or in specific fields in the body of a reply message.

Finally, the reply containing the data is transmitted to the sender, as shown in step 34. Alternatively, the data could be transmitted to a third party. In either case, the electronic mail address to which the data is to be transmitted may optionally be specified in the electronic mail message, e.g., in a “Reply to” field.

Alternatively, steps 32 and 34 may involve transmitting to a sender of said electronic mail message, or to a third party only the data, or a new electronic mail message containing only the data.

In one embodiment, the method includes an additional step in which the recipient is prompted to perform an action to confirm transmission of the data after the data is displayed to the recipient.

From the recipient's perspective, the process then ends, as shown at step 35 in FIG. 2.

The reply message transmitted from the recipient in step 34 of FIG. 2 is now received by the sender, as shown at step 18 in FIG. 1. The required data incorporated into the electronic mail reply in step 32 of FIG. 2 is then extracted from the reply, as shown at step 20 of FIG. 1. For example, the extraction step may involve reading, storing, copying form-filling and/or transmitting of the data by a human or, preferably, the sender's computer system. This requires software in accordance with the present invention. Programming methods and techniques for developing such software are well known in the art.

Finally, the transaction is processed using the required data, as shown at step 22 of FIG. 1, and the method ends, as shown at step 23 of FIG. 1. For example, the processing may include generating an order and/or executing the sale transaction. In the example of FIGS. 1-2, this may include submitting the recipient's name, shipping address and credit card number to an order processing subsystem of the sender's computer system and/or mailing the beauty product to Jane F. Doe at her shipping address of 123 Main Street, Springfield, Mass. 99999 and charging her credit card number 1234567890 in the amount of $19.95. For example, the rule may include checking the recipient-specific data to determine the state of residence of the buyer, and then charging applicable state sales tax to the same credit card number. Additional information may be extracted from or otherwise associated with the electronic mail reply to identify the beauty product that the recipient wishes to purchase. For example, it may be included in the rule as a necessary data element and specified by the sender when the sender specifies the rule and/or attempts to send the electronic mail message without having provided a description of the beauty product or other identifying information. This may require further processing at the sender side, e.g., to extract a beauty product or transaction specific identifier (e.g., for the particular beauty product that is the subject of the sale offer) from the electronic mail message. Additionally, the rule may require data elements to be retrieved from a sender profile data store storing sender-specific or recipient-specific data. Methods and apparatuses for rule-based processing to access data stored at a sender is disclosed in U.S. application Ser. No. ______ titled System and Method for Conducting Predefined Transactions via an Electronic Mail Messaging Infrastructure (Attorney Docket No. P24526 USA), filed ______, now U.S. Pat. No. ______, issued , and in U.S. application Ser. No. ______ titled System and Method for Rule-based Processing of Electronic Mail Messages (Attorney Docket No. P24528 USA), filed ______, now U.S. Pat. No. ______, issued ______, the disclosures of which are incorporated herein by reference.

The hardware of the sender device, receiver device and trusted authority device are of types generally known in the art. As shown in FIG. 3, these devices are capable of communication via a communications network, e.g., such as the Internet 200, e.g., using known communications protocols. The sender device 130 may be any device capable of sending electronic mail messages, or if all the recipient's personal data is stored remotely, the device could be an automated dialer for outbound telemarketing calls. For example, the sender device 130 may include a general purpose computer configured with mail composing or instant messaging software, a pager, a wireless telephone, a personal digital assistant device such as a Palm VII® device, etc. The receiver device 160 may be any device capable of receiving electronic mail messages, such as a general purpose computer configured with mail reader software, a pager, a wireless telephone, a personal digital assistant device such as a Palm VII® device, etc. and, if all of the recipient's personal data is stored remotely and the sender utilizes an automated dialer for outbound telemarketing calls, the recipient device could be a telephone. Each of these devices (other than a telephone) 130, 160 includes a central processing unit (“CPU”), a memory, e.g., random access memory (“RAM”), read only memory (“ROM”) and/or a storage device such as a hard disk drive, and a telecommunications device for communicating via a communications network, e.g., using TCP/IP technology. The telecommunications device may include a modem and/or a network card connected via a communications port. Each device may optionally include a video display device and/or input devices.

The subscriber device 130, 160 stores in its memory a first program executable by the CPU for identifying a rule applicable to an electronic mail message; a second program executable by the CPU for identifying at least one data element required for said rule, a third program executable by the CPU for retrieving from a first data store data corresponding to the at least one data element, and a fourth program executable by the CPU for associating the data with said electronic mail message. The fourth program may optionally include instructions for transmitting the electronic mail message including data corresponding to the at least one data element.

Each subscriber device 130, 160 store in its memory a first data store storing data corresponding to at least one data element, the data being specific to a subscriber. For example, the sender may stored sender profile data in a sender profile data store 132 and the recipient may store recipient profile data in a recipient profile data store 162. Optionally, the sender may also store recipient specific data in a recipient profile data store—for example, Amazon.com, Inc. may store some recipient-specific information for recipients registered as users with Amazon.com, Inc. Each subscriber device also stores typical mail client software 134, 164 for sending and/or receiving mail. Each sender device stores a sender rule base 136 and each recipient device stores a recipient rule base 166. These rule bases may contain at least some identical rules. Each rule base is a second data store storing at least one rule specifier corresponding to a respective rule relating to the data element. The sender and receiver devices also store rule processing and/or specification software 138, 168.

The trusted authority device 190 includes a central processing unit, a memory operatively connected to the central processing unit, a telecommunications device operatively connected to said central processing unit and capable of communicating via a communications network, and a master data store stored in its memory. The master data store stores a plurality of rules in a master rule base 192. Each of the plurality of rules relates to at least one data element. The trusted authority also stores in its memory a first program executable by the CPU for transmitting at least one of the plurality of rules via said communications network, e.g. to one or more subscribers.

The trusted authority device 190 may also store in its memory a second program executable by the CPU for storing the rule in its master data store and/or a third program for receiving an additional rule via a communications network. In this manner, senders and/or receivers may propose rules to the trusted authority for approval. The trusted authority may store the rule in its master rule base and propagate the rule to senders and receivers registered with the trusted authority for use thereby if the trusted authority chooses to approve the rule. Approval of rules by the trusted authority gives senders and receivers confidence to conduct transactions via the system and lends trust to transactions conducted thereby.

It is noted that the present invention may be advantageously combined with a dynamic prioritization system and/or categorization system such as that disclosed in U.S. application Ser. No. ______ titled Method And Apparatus For Dynamic Prioritization of Electronic Mail Messages (Attorney Docket No. P24773 USA), filed ______, now U.S. Pat. No. ______, issued ______, and/or spam routing systems such as those disclosed in U.S. application Ser. No. ______ titled Method And Apparatus For Selective Delivery And Forwarding of Electronic Mail (Attorney Docket No. P24618 USA), filed , now U.S. Pat. No. ______, issued ______, and/or U.S. application Ser. No. ______ titled Spam Squelcher (Attorney Docket No. P24784 USA), filed ______, now U.S. Pat. No. ______, issued ______, the disclosures of which are incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for conducting a predefined transaction via electronic mail messaging, the method comprising the steps of:
(a) receiving an electronic mail message prescribing a reply action to be taken by a recipient to indicate said recipient's desire to complete said transaction;
responsive to said recipient's performance of said reply action:
(b) identifying a rule applicable to said electronic mail message;
(c) retrieving from a first data store data required by said rule; and
(d) transmitting, via an electronic mail infrastructure, said data for completing said transaction.

2. The method of claim 1, wherein said electronic mail message comprises said rule.

3. The method of claim 1, wherein said rule requires at least one data element and said first data store stores data in association with a plurality of data elements.

4. The method of claim 1, wherein step (b) comprises the steps of:
(e) identifying a rule specifier included in said electronic mail message; and
(f) referencing a second data store of rule specifiers, each of said rule specifiers corresponding with a respective rule.

5. The method of claim 4, wherein step (e) comprises the step of:
(g) identifying a rule specifier in a header portion of said electronic mail message

6. The method of claim 1, wherein said first data store is stored locally.

7. The method of claim 1, wherein said first data store is stored at an intermediary accessible via a communications network.

8. The method of claim 1, wherein said second data store is stored locally.

9. The method of claim 1, wherein said second data store is stored at an intermediary accessible via a communications network.

10. The method of claim 1, wherein steps (b) and (c) are performed at an intermediary.

11. The method of claim 10, wherein steps (b) and (c) are performed after said message is transmitted from said recipient.

12. The method of claim 2, further comprising the step of:
(h) storing in said first data store data corresponding to a plurality of data elements, said data being specific to a recipient of said electronic mail message; step (h) being performed before step (c).

13. The method of claim 1, wherein step (d) comprises transmitting said data to a sender of said electronic mail message.

14. The method of claim 13, wherein step (d) comprises transmitting said electronic mail message to said sender in a reply.

15. The method of claim 14, wherein step (d) comprises transmitting said using a reply function of a mail client software program.

16. The method of claim 1, further comprising the steps of:
(h) displaying said data; and
(i) prompting said recipient to confirm transmission of said data;
steps (h) and (i) being performed before step (d).

17. The method of claim 13, wherein step (d) comprises the step of:
(j) modifying said electronic mail message to include said data.

18. The method of claim 1, wherein said prescribed action comprises typing of a keyword into a reply message and selecting a send option of a mail software program.

19. The method of claim 1, wherein said prescribed action comprises selection of a button included in said electronic mail message.

20. The method of claim 1, wherein said prescribed action comprises executing a reply command of a mail client software program.

21. The method of claim 1, wherein said transaction is a sale transaction.

22. A method for conducting a predefined transaction via electronic mail messaging, the method comprising the steps of:
(a) preparing an electronic mail message prescribing a reply action to be taken by a recipient to indicate said recipient's desire to complete said transaction;
responsive to said recipient's performance of said reply action:
(b) specifying a rule applicable to said electronic mail message, said rule identifying data required to complete said transaction;
(c) receiving said data via an electronic mail via an electronic mail infrastructure; and
(d) processing said data to complete said transaction.

23. The method of claim 22, wherein step (b) comprises including said rule in said electronic mail message.

24. The method of claim 23, wherein step (b) comprises including a rule specifier in said message, said rule specifier identifying said rule.

25. A method for conducting a predefined transaction via electronic mail messaging, the method comprising the steps of:
(a) sending an electronic mail message prescribing a reply action to be taken by a recipient to indicate said recipient's desire to complete said transaction;
(b) receiving via an electronic mail infrastructure an indication of said recipient's performance of said reply action;
(c) retrieving from a first data store data required by said rule; and
(d) completing said transaction.

26. The method of claim 25, wherein step (b) comprises the step of:
(e) receiving a reply from said recipient via an electronic mail infrastructure.

27. The method of claim 26, wherein said reply comprises an electronic mail message reply.

28. The method of claim 25, further comprising the step of:
(e) identifying a rule applicable to said electronic mail message.

29. The method of claim 25, wherein steps (b)-(d) are performed by a sender's communications device.

30. The method of claim 25, wherein said first data store is stored in a memory of said sender's communications device.

31. The method of claim 25, wherein said transaction is a sale transaction.

32. The method of claim 25, wherein said transaction is a non-sale transaction.

33. A device for conducting a predefined transaction via electronic mail messaging, the device comprising:
a central processing unit;
a memory operatively connected to said central processing unit;
a telecommunications device operatively connected to said central processing unit and capable of communicating via a communications network;
a first program stored in said memory and executable by said central processing unit for receiving an electronic mail message prescribing a reply action to be taken by a recipient to indicate said recipient's desire to complete said transaction;
a second program stored in said memory and executable by said central processing unit for identifying a rule applicable to said electronic mail message;
a third program stored in said memory and executable by said central processing unit for retrieving from a first data store data required by said rule; and
a fourth program stored in said memory and executable by said central processing unit for transmitting, via an electronic mail infrastructure, said data for completing said transaction.

34. The device of claim 33, further comprising:
a first data store stored in said memory, said first data store storing data required by said rule, said data being specific to said recipient

35. The device of claim 33, further comprising:
a second data store stored in said memory, said second data store storing at least one rule requiring said data.

36. A device for conducting a predefined transaction via electronic mail messaging, the device comprising:
a central processing unit;
a memory operatively connected to said central processing unit;
a telecommunications device operatively connected to said central processing unit and capable of communicating via a communications network;
a first program stored in said memory and executable by said central processing unit for preparing an electronic mail message prescribing a reply action to be taken by a recipient to indicate said recipient's desire to complete said transaction;
a second program stored in said memory and executable by said central processing unit for specifying a rule applicable to said electronic mail message, said rule identifying data required to complete said transaction;
a third program stored in said memory and executable by said central processing unit for receiving said data via an electronic mail via an electronic mail infrastructure; and
a fourth program stored in said memory and executable by said central processing unit for processing said data to complete said transaction.

37. The device of claim 36, further comprising:
a first data store stored in said memory, said first data store storing data required by said rule, said data being specific to said recipient.

38. The device of claim 36, further comprising:
a second data store stored in said memory, said second data store storing at least one rule requiring said data.

39. A device for conducting a predefined transaction via electronic mail messaging, the device comprising:
a central processing unit;
a memory operatively connected to said central processing unit;
a telecommunications device operatively connected to said central processing unit and capable of communicating via a communications network;
a first data store stored in said memory, said first data store storing data specific to a recipient;
a first program stored in said memory and executable by said central processing unit for sending an electronic mail message prescribing a reply action to be taken by said recipient to indicate said recipient's desire to complete said transaction;
a second program stored in said memory and executable by said central processing unit for receiving via an electronic mail infrastructure an indication of said recipient's performance of said reply action;
a third program stored in said memory and executable by said central processing unit for retrieving from said first data store data required by said rule; and
a fourth program stored in said memory and executable by said central processing unit for completing said transaction.

40. The device of claim 39, further comprising:
a fifth program stored in said memory and executable by said central processing unit for receiving a reply from said recipient via an electronic mail infrastructure.

41. A method for conducting a predefined transaction via electronic mail messaging, the method comprising the steps of:
(a) receiving an electronic mail message indicating a party's desire to conduct a transaction;
(b) identifying a rule applicable to said electronic mail message;
(c) retrieving from a first data store data required by said rule; and
(d) processing said data to conduct said transaction.

42. A method for conducting a predefined transaction via electronic mail messaging, the method comprising the steps of:
(a) receiving an electronic mail message indicating a party's desire to conduct a transaction;
(b) identifying a rule applicable to said electronic mail message, said rule providing logic for processing a reply to said electronic mail message responsive to a prescribed action performed by said party;
(c) retrieving from a first data store data required by said rule; and
(d) processing said data to conduct said transaction.
